(19) United States
(12) Patent Application Publication
(10) Pub. No.: US 2026/0300878 A1
(43) Pub. Date: Oct. 1, 2026

(54) SECURE DISTRIBUTED COMPUTING SYSTEM WITH HARDWARE-ISOLATED BIOMETRIC PROCESSING AND CRYPTOGRAPHICALLY-SECURED RISK ASSESSMENT

(71) Applicant: Johnson Heritage Group Series B, LLC, Chicago, IL (US)

(72) Inventor: Jamira O. Owokoniran, Chicago, IL (US)

(73) Assignee: Johnson Heritage Group Series B, LLC, Chicago, IL (US)

(21) Appl. No.: 19/438,372

(22) Filed: Dec. 31, 2025

Related U.S. Application Data
(60) Provisional application No. 63/778,369, filed on Mar. 26, 2025.

(51) Int. Cl. G06Q 10/0635; G06F 21/32; G06Q 50/16

(52) U.S. Cl. CPC G06Q 10/0635; G06F 21/32; H04L 63/08; G06Q 50/16

(57) ABSTRACT

An AI-integrated property authentication ecosystem having biometric identity verification, artificial intelligence-based fraud detection, deed locking mechanisms, and law enforcement verification capabilities. The system receives and verifies property ownership through biometric authentication, continuously monitors multiple data sources including utility activations, mail delivery, and disaster declarations to generate real-time fraud risk scores, automatically locks property deeds when fraud is detected, and provides law enforcement officers with instant field access to verified ownership information and lease validation. The system operates on a hybrid-cloud architecture with government-grade security and employs machine learning models that continuously improve fraud detection accuracy. The AI-integrated property authentication ecosystem provides end-to-end fraud prevention with verified identity, multi-signal AI analysis, and law-enforcement verification, addressing property fraud, deed theft, title fraud, and squatting by providing comprehensive protection from initial registration through closing table verification to law enforcement response.

### CROSS-REFERENCE TO RELATED APPLICATION

This application is a nonprovisional application of U.S. Patent Application No. 63/778,369, filed on Mar. 26, 2025, and incorporated in its entirety.

### FIELD OF DISCLOSURE

This disclosure relates generally to the field of secure distributed computing systems with hardware-isolated data processing, and in particular to systems and methods for real-time biometric authentication, cryptographically-secured risk analysis, and distributed data verification using hybrid-cloud architecture with trusted execution environments.

### BACKGROUND

Property fraud represents a significant and growing threat to property owners across the United States. According to industry reports, deed fraud has increased dramatically in recent years, particularly in areas affected by natural disasters where properties may be vacant or where owners are displaced. Fraudsters exploit vulnerabilities in the property transfer system by filing forged deeds, impersonating owners, or taking advantage of vacant properties to establish fraudulent claims of ownership or tenancy.

Traditional property monitoring services provide basic notification when deed activity occurs, but they lack comprehensive fraud prevention capabilities. These conventional systems cannot prevent fraudulent transfers in real-time, do not integrate biometric verification, and fail to provide law enforcement with tools to quickly verify legitimate ownership when responding to property disputes or trespassing calls.

When law enforcement officers respond to calls involving potential squatters or property disputes, they often face significant challenges in quickly determining the legitimate owner of a property and whether an occupant's claims of tenancy or ownership are valid. Officers typically must rely on outdated records, verbal claims from disputing parties, or time-consuming manual verification processes. This delay can result in legitimate property owners being denied access to their own property while fraudulent occupants remain in possession, sometimes for months during legal proceedings.

Thus, a comprehensive, integrated property fraud prevention system that combines biometric identity verification, artificial intelligence-based fraud detection, deed locking mechanisms, multi-source monitoring, disaster risk integration, and law enforcement verification tools is needed to address the growing threat of property fraud and provide property owners with robust protection of their most valuable asset.

### SUMMARY

The system operates as an end-to-end protection pipeline. A biometric owner registration module establishes a cryptographically verifiable link between a deed record and a non-invertible biometric template, ensuring that only a verified owner profile can approve sensitive actions. An AI fraud-scoring engine continuously ingests recorder activity, lien filings, utility activation and usage patterns, mail-recipient and forwarding changes, and disaster-zone overlays to compute a calibrated, continuously updated fraud risk score. A title control enforces a cryptographic freeze that prevents transfer or modification of the deed unless biometric re-verification and owner consent succeed, with policy granularity allowing different authentication requirements for different instruments. To resolve disputes rapidly in the field, a law-enforcement verification portal acts as a “license plate reader for property,” returning owner identity (biometric-verified), current lock state, risk score with salient factors, and the presence or absence of a validated lease, with all accesses recorded to a tamper-evident audit log. The ecosystem runs in a hybrid, compliance-aligned cloud that employs confidential-computing enclaves for biometric template generation and key custody, while analytics uses tokenized identifiers to minimize exposure of personally identifiable information.

The system provides distributed computing systems with hardware-isolated biometric processing for real-time authentication and risk assessment. The system employs a hybrid-cloud architecture with secure enclaves providing processor-level memory encryption for biometric operations. A first government-compliant cloud environment maintains encrypted data with FIPS 140-2 cryptographic protection. A second analytics cloud environment executes machine learning models using GPU-accelerated processing. Secure communication channels with mutual TLS authentication connect the environments. The system aggregates data from heterogeneous sources through parallel processing, performs risk analysis using trained neural networks, and generates tamper-evident audit logs through cryptographic hash chaining. Edge computing interfaces enable offline operation with hardware-backed keystores and background synchronization. The architecture achieves sub-second processing latency while maintaining hardware-enforced data isolation and cryptographic integrity proofs.

The disclosure presented herein relates to a property fraud prevention system including one or more databases coupled via a network, one or more processors coupled to the one or more databases, and at least one computing device coupled to the one or more processors and the one or more databases via the network. The one or more processors are configured to: receive a deed record associated with a property via a property registration module; authenticate an owner of the property using biometric verification including at least one of a fingerprint or facial scan via a biometric verification module; receive inputs comprising property ownership history, lien filing records, biometric verification status, utility activation records, mail delivery records, and disaster-related data via a fraud scoring engine; generate a fraud risk score associated with the property based on the received inputs; freeze or unfreeze the deed record based on the fraud risk score and biometric authentication via a title locking mechanism; and provide real-time access via a verification portal accessible by law enforcement to at least one of: verified owner identity, deed lock status, fraud risk score, or valid lease records associated with the property.

The system further comprises biometric authentication that is re-confirmed during a property closing to prevent fraudulent transfer; wherein the fraud scoring engine applies both a rule-based baseline and a machine learning model to generate the fraud risk score; wherein the property registration module stores the biometric authentication result as a verified identity flag linked to the deed record; wherein the title locking mechanism requires biometric re-verification of the owner to unfreeze the deed record; wherein a cross-agency verification API connects title companies, law enforcement, and utility providers for ownership validation; wherein the verification portal provides law enforcement with an indicator of whether a lease presented by an occupant matches a verified lease record in the system; wherein the fraud scoring engine increases the fraud risk score when the property is located within a disaster zone declared by the Federal Emergency Management Agency (FEMA); wherein the fraud scoring engine lowers the fraud risk score upon confirmation of owner activity consistent with verified utility activations; further comprising a residency monitoring module configured to generate alerts when new mail recipients are detected at the property address; wherein the fraud scoring engine generates the fraud risk score on a continuous basis and updates the score upon receiving new ownership, utility, or mail activity; wherein the system records each fraud-related event in a tamper-evident log accessible to authorized auditors; and wherein all modules operate within a secure enclave computing environment providing hardware-level encryption and data isolation.

The disclosure presented herein further relates to a computer-implemented method for preventing property fraud, the method including: receiving, via a property registration system, a deed record associated with a property; verifying an identity of a property owner using biometric authentication; automatically monitoring and parsing external datasets including at least one of: ownership history, utility activation, mail delivery, and disaster zone data; generating, by a fraud scoring engine, a fraud risk score for the property based on the external datasets and the biometric authentication; automatically locking the deed record when the fraud risk score exceeds a threshold; and providing, via a law enforcement portal, real-time verification of the owner identity, deed lock status, fraud risk score, and lease validity.

The method further comprises: cross-checking the biometric authentication against a government-issued identification document using optical character recognition; wherein the AI engine continuously refines fraud predictions based on confirmed fraud or false-positive feedback; wherein the fraud risk score is calculated using a machine learning model trained on historical deed fraud patterns; alerting a property owner when unauthorized utility activation is detected; alerting a property owner when mail forwarding or new recipients are detected at the property address; providing law enforcement with a confirmation that an occupant's lease is fraudulent based on absence of a matching verified lease record; and wherein the system delivers alerts to the property owner through one or more automated communication channels selected from the group consisting of: push notification, application programming interface (API) webhook, electronic mail, or short message service (SMS) text message, responsive to detection of unauthorized property-related activity.

In some aspects, the techniques described herein relate to a system for preventing property fraud, including: a property registration module configured to receive a deed record associated with a property; a verification system; a fraud scoring system configured to receive inputs including property ownership history, lien filings, utility records, mail delivery records, and disaster-related data; generate a fraud risk score associated with the property; and a title locking mechanism configured to freeze or unfreeze the deed record based on the fraud risk score and biometric authentication.

In some aspects, the techniques described herein relate to a system further including a verification portal accessible by law enforcement, the portal configured to provide in real time at least one of: a verified owner identity, a deed lock status, the fraud risk score, or a record of valid leases associated with the property.

In some aspects, the techniques described herein relate to a system, wherein the verification system is a biometric authentication system wherein the biometric authentication is re-confirmed during a property closing to prevent fraudulent transfer.

In some aspects, the techniques described herein relate to a system, further including a fraud scoring engine wherein the fraud scoring engine applies both a rule-based baseline and a machine learning model to generate the fraud risk score.

In some aspects, the techniques described herein relate to a system, wherein the property registration module stores a verification result as a verified identity flag linked to the deed record.

In some aspects, the techniques described herein relate to a system, wherein the title locking mechanism requires a re-verification of an owner to unfreeze the deed record.

In some aspects, the techniques described herein relate to a system, wherein a cross-agency verification system connects the system with title companies, law enforcement, and utility providers for ownership validation.

In some aspects, the techniques described herein relate to a system, wherein the verification portal provides the law enforcement with an indicator of whether a lease presented by an occupant matches a verified lease record in the system.

In some aspects, the techniques described herein relate to a system, wherein the fraud scoring engine increases the fraud risk score when the property is located within a disaster zone declared by Federal Emergency Management Agency (FEMA).

In some aspects, the techniques described herein relate to a system, wherein the fraud scoring engine lowers the fraud risk score upon confirmation of owner activity consistent with verified utility activations.

In some aspects, the techniques described herein relate to a system, wherein the fraud scoring engine raises the fraud risk score upon confirmation of owner activity not consistent with verified utility activations.

In some aspects, the techniques described herein relate to a system, further including a residency monitoring module configured to generate alerts when new mail recipients are detected at a property address.

In some aspects, the techniques described herein relate to a system, wherein the fraud scoring engine generates the fraud risk score on a continuous basis and updates the score upon receiving new ownership, utility, or mail activity.

In some aspects, the techniques described herein relate to a system, wherein the system records each fraud-related event in a tamper-evident log accessible to authorized auditors.

In some aspects, the techniques described herein relate to a system, wherein all modules operate within a secure enclave computing environment providing hardware-level encryption and data isolation.

In some aspects, the techniques described herein relate to a computer-implemented method for preventing property fraud, including: receiving, via a property registration system, a deed record associated with a property; verifying an identity of a property owner; automatically monitoring and parsing external datasets including at least one of: ownership history, utility activation, mail delivery, and disaster zone data; generating, by a fraud scoring engine, a fraud risk score for the property based on the external datasets and biometric authentication; automatically locking the deed record when the fraud risk score exceeds a threshold; and providing, via a law enforcement portal, real-time verification of the owner identity, deed lock status, the fraud risk score, and lease validity.

In some aspects, the techniques described herein relate to a method, wherein an AI engine continuously refines fraud predictions based on confirmed fraud or false-positive feedback.

In some aspects, the techniques described herein relate to a method, wherein the fraud risk score is calculated using a machine learning model trained on historical deed fraud patterns.

In some aspects, the techniques described herein relate to a method, further including alerting the property owner when unauthorized utility activation is detected.

In some aspects, the techniques described herein relate to an AI-integrated property authentication ecosystem, including: a biometric registration system for verifying property owners at onboarding; a deed locking system for freezing title transfers until verification is complete; an artificial intelligence fraud scoring engine for prioritizing fraud risk; a utility and mail monitoring system for detecting unauthorized residency; a disaster risk integration system for adjusting fraud scores in response to natural disasters; a law enforcement verification interface configured to provide officers with field-ready access to verified property ownership and occupancy data, wherein the ecosystem operates within a hybrid-cloud architecture including a government-compliant cloud environment for data storage and a separate analytical cloud environment for AI processing.

### DEFINITIONS

Memory refers to a computer memory, which is any physical device capable of storing information temporally or permanently. For example, Random Access Memory (RAM) is a volatile memory that stores information on an integrated circuit used by the operating system, software, and hardware.

A server is a computer that provides data to other computers. It may serve data to systems on a local area network (LAN) or a wide area network (WAN) over the Internet.

Local area network (LAN) may serve as few as two or three users (for example, in a small-office network) or several hundred users in a larger office. LAN networking comprises cables, switches, routers and other components that let users connect to internal servers, websites and other LANs via wide area networks.

Wide area network (WAN) is a geographically distributed private telecommunications network that interconnects multiple local area networks (LANs).

Wi-Fi is the standard wireless local area network (WLAN) technology for connecting computers and a myriad of electronic devices to each other and to the Internet. Wi-Fi is the wireless version of a wired Ethernet network, and it is commonly deployed alongside Ethernet.

Database is an electronic filing system, generally on a computer. A collection of information (usually as a group of linked data files) organized in such a way that a program can quickly select pieces of data.

Computer network (“network”) is a group of computer systems and other computing hardware devices that are linked together through communication channels to facilitate communication and resource-sharing among a wide range of users.

Computing device is any electronic equipment controlled by a CPU (Central Processing Unit), including desktop and laptop computers, smartphones, and tablets. It usually refers to a general-purpose device that can accept software for many purposes in contrast with a dedicated unit of equipment such as a network switch or router.

Biometric data refers to unique physical or behavioral characteristics used for identification, including fingerprints, facial recognition patterns, iris scans, voice patterns, and other biological identifiers.

Deed record refers to the legal document that transfers ownership of real property from one party to another, including all associated metadata and filing information maintained by county recording offices or other governmental entities.

Fraud risk score refers to a numerical or categorical assessment of the likelihood that fraudulent activity has occurred or may occur related to a property, calculated based on multiple data inputs and risk factors.

Title locking mechanism refers to digital security control that prevents or restricts the transfer or modification of property deed records without proper authorization and authentication.

Secure enclave refers to a hardware-based trusted execution environment that provides isolation and protection for sensitive data and operations through hardware-level encryption and access controls.

### BRIEF DESCRIPTION OF DRAWINGS

The present invention will be described by way of exemplary embodiments, but not limitations, illustrated in the accompanying drawings in which like references denote similar elements, and in which:

FIGS. 1-13 illustrate the user interface flow of the property fraud prevention system.

FIG. 14 illustrates a block diagram showing the property fraud prevention system with users, computing devices, network, server modules, and databases.

FIG. 15 illustrates a flowchart depicting the property owner registration and biometric verification process FIG. 16 illustrates a flowchart for law enforcement verification of property ownership and occupancy FIG. 17 illustrates a flowchart showing continuous fraud detection, risk scoring, and automated deed locking.

FIG. 18 illustrates a block diagram of computing device hardware showing CPU, memory, input/output devices, and network connections.

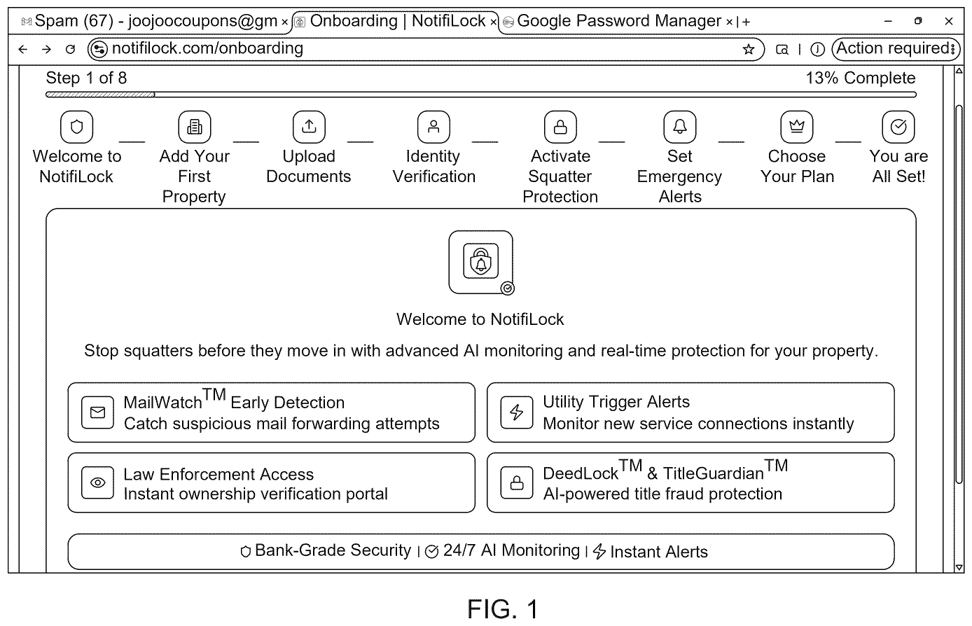

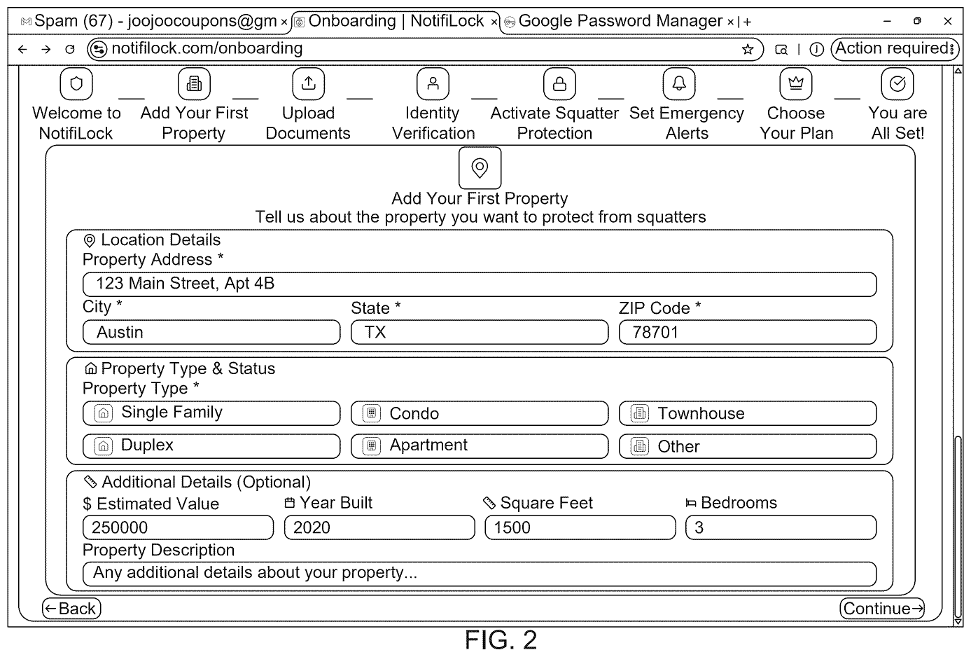

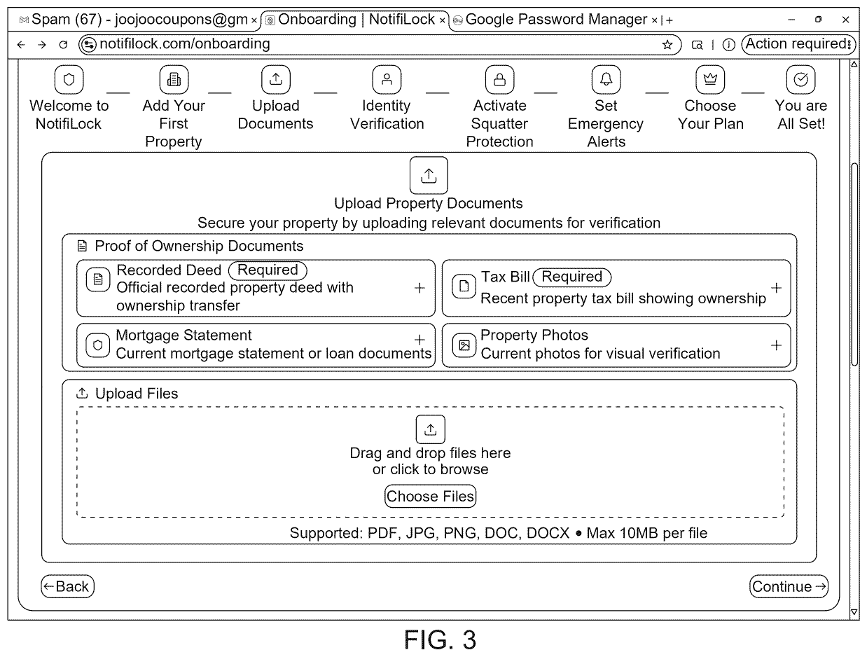

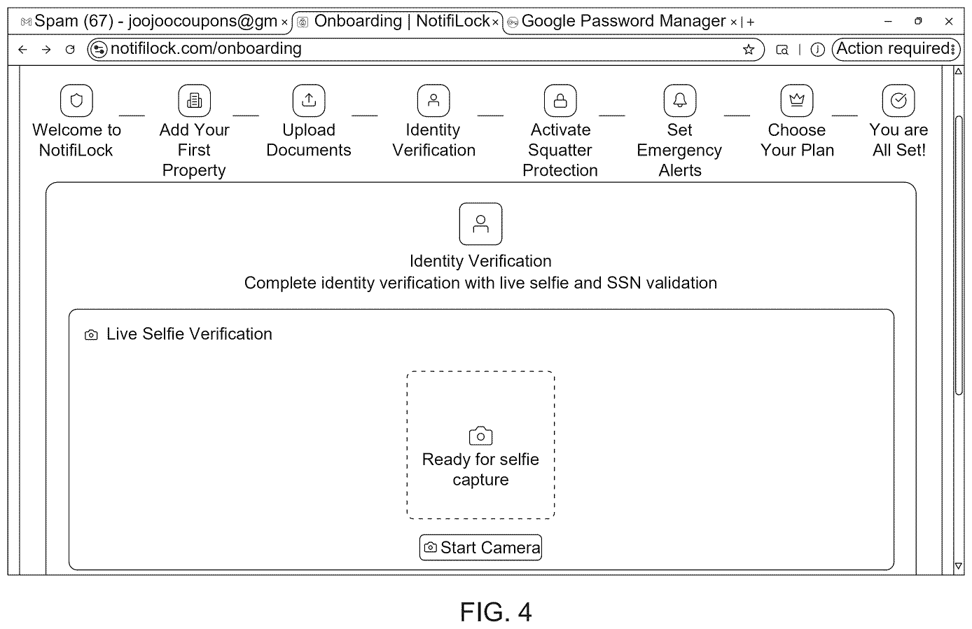

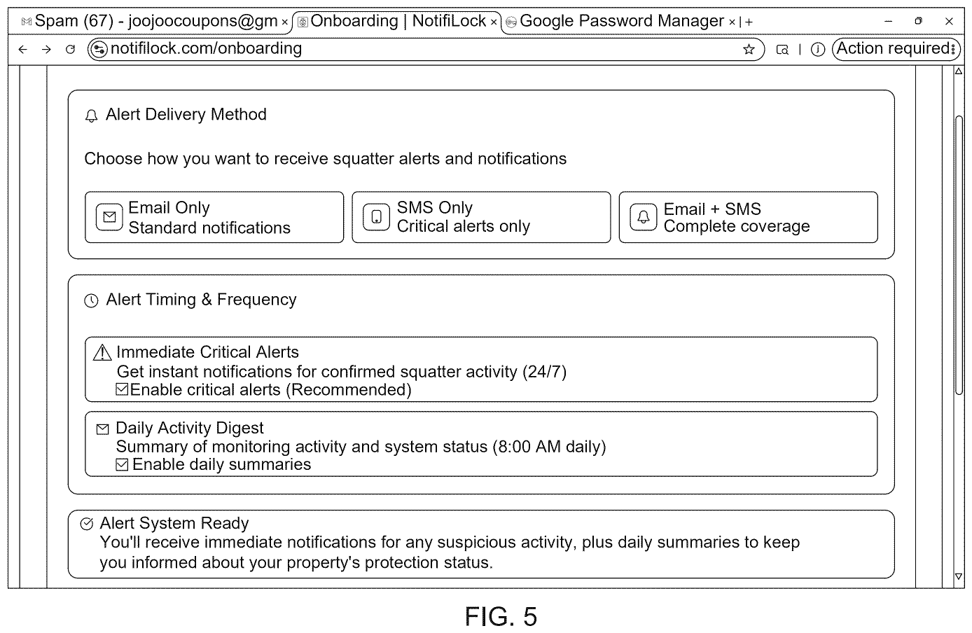

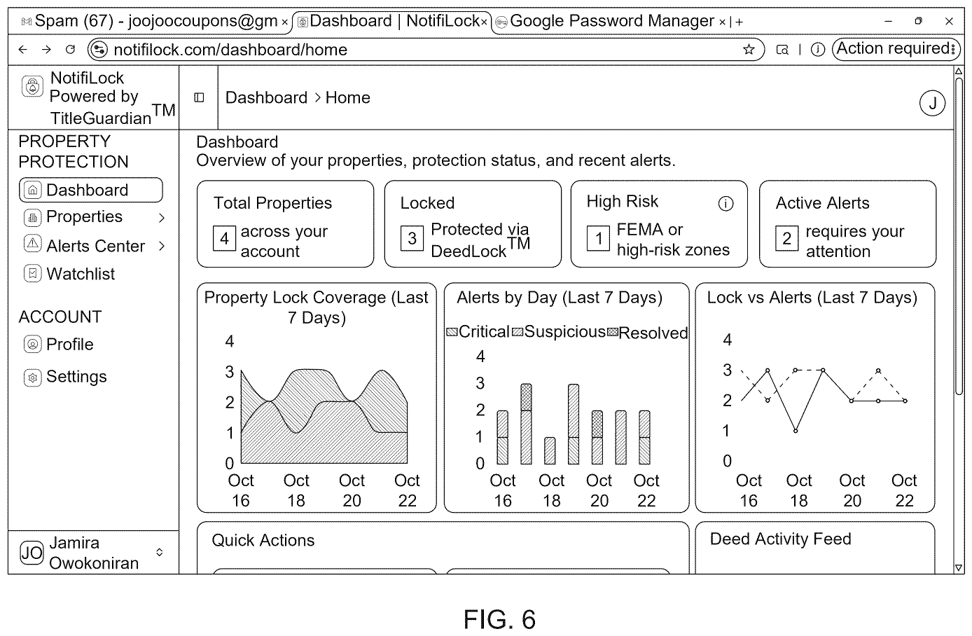

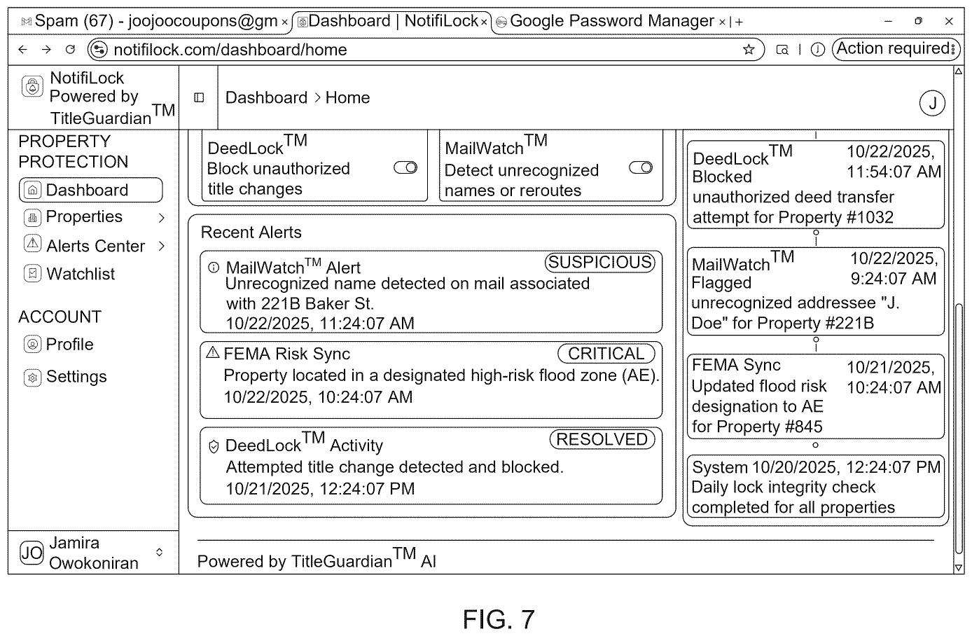

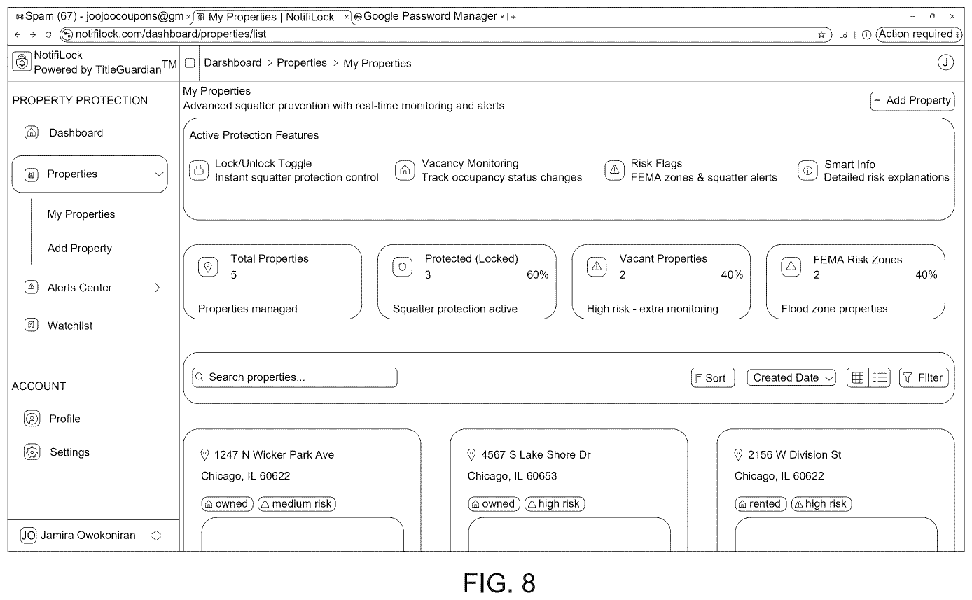

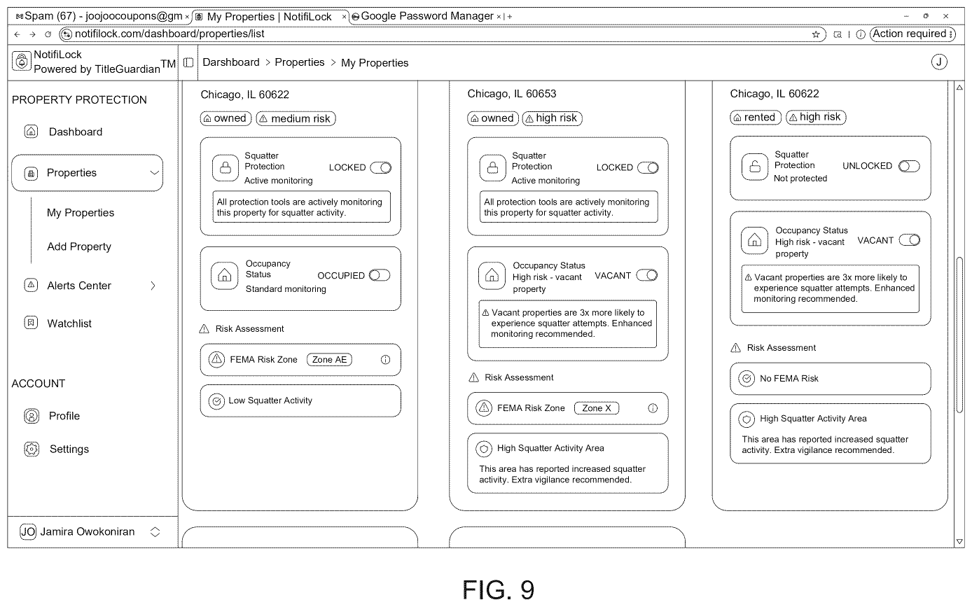

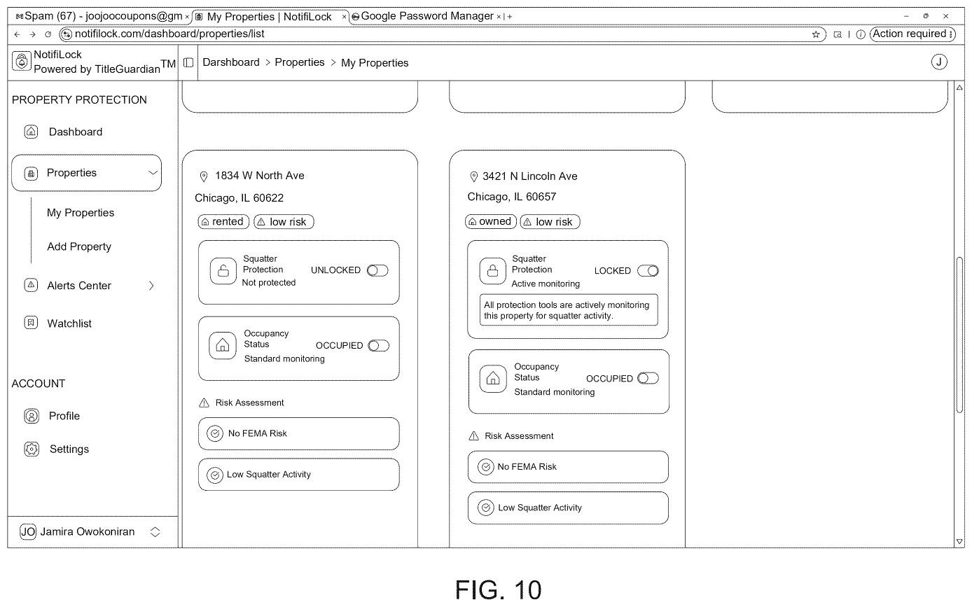

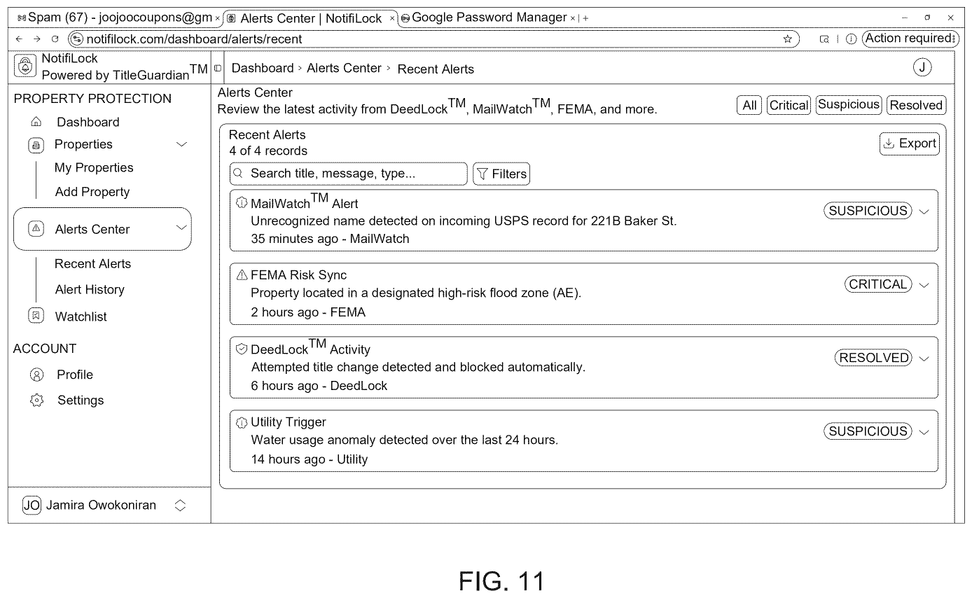

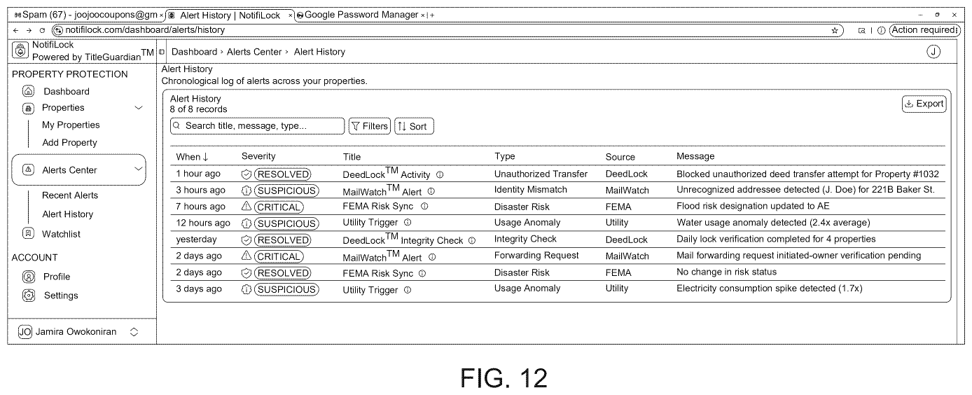

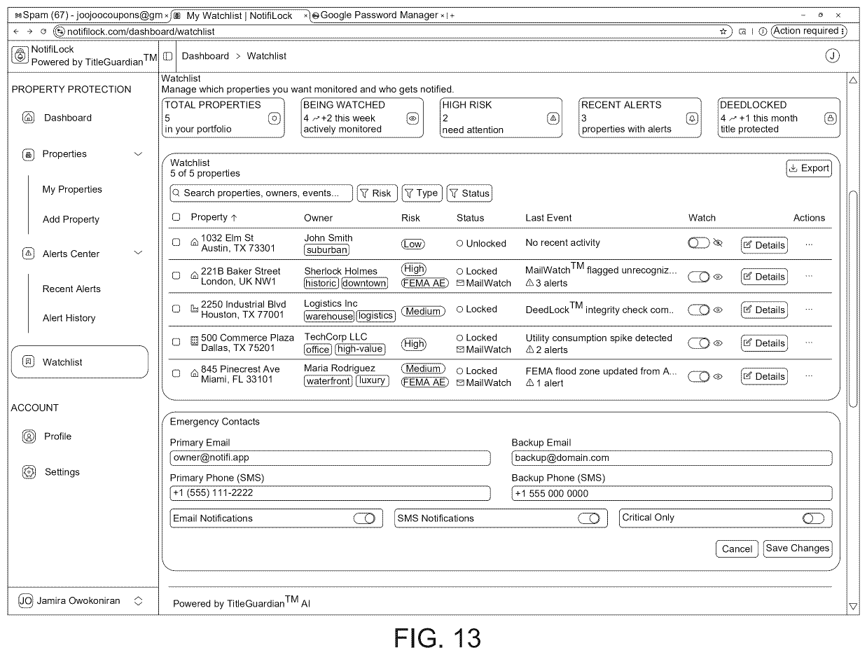

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

The present invention relates to an AI-integrated property authentication ecosystem that provides property owners with protection against deed fraud, title theft, squatting, and unauthorized occupancy. The system integrates biometric identity verification, artificial intelligence-based fraud detection, real-time monitoring of multiple data sources, deed locking capabilities, and field-deployable law enforcement verification tools into a unified platform.

Unlike traditional property monitoring services that merely alert owners to deed activity after it occurs, the present invention provides proactive fraud prevention through multi-layered security controls. The system prevents fraudulent transfers before they are completed, validates owner identity at critical touchpoints including property registration and closing transactions, and provides law enforcement with instant verification capabilities to resolve property disputes in the field.

The invention addresses the fundamental challenge that property records systems were designed for record-keeping rather than fraud prevention. By layering biometric authentication, AI-powered risk analysis, and real-time monitoring atop existing property records infrastructure, the system creates a comprehensive fraud prevention shield while maintaining compatibility with existing legal and administrative frameworks.

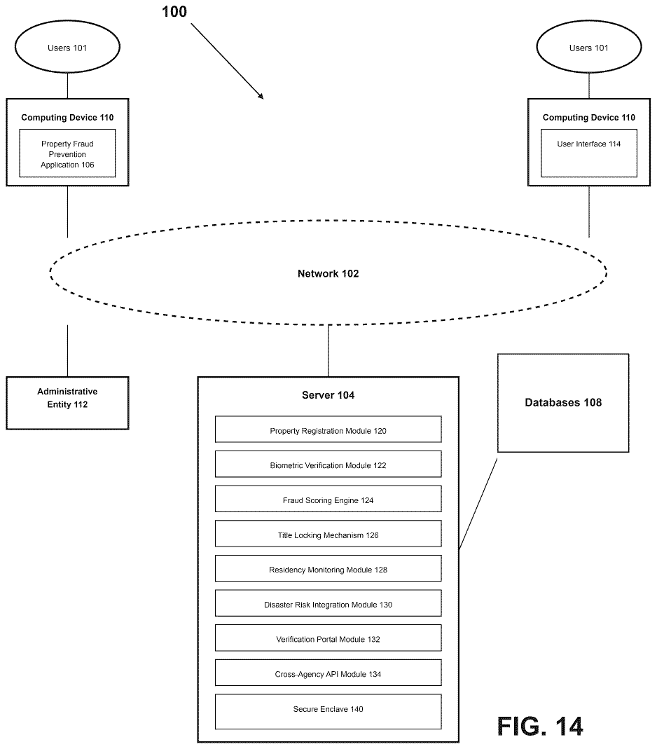

FIG. 14 illustrates a block diagram of a property fraud prevention system 100 in accordance with one or more embodiments of the present invention. Property fraud prevention system 100 may be utilized by users such as users 101, whereby users 101 interact with an application such as property fraud prevention application 106. Users 101 may be located at any physical location as desired by users 101. Users 101 may include without limitation property owners, title company personnel, law enforcement officers, utility company personnel, real estate agents, closing attorneys, government officials, or any other authorized users.

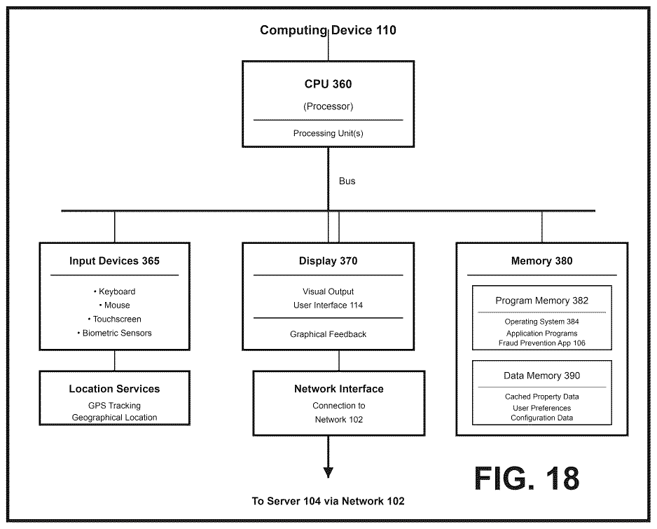

Property fraud prevention application 106 may be downloadable and installable by a user onto any suitable computing device, such as computing device 110. A computing device, such as computing device 110, and exemplary components are discussed in more detail later in the description with respect to at least FIG. 18. In some embodiments, property fraud prevention application 106 may be preinstalled on computing devices 110 by the manufacturer or designer or other entity. Further, property fraud prevention application 106 may be implemented using a web browser via a browser extension or plugin.

Further, a user interface, such as user interface 114, may be displayed to users 101 via property fraud prevention application 106. User interface 114 may be included with property fraud prevention application 106. User interface 114 may have a plurality of buttons or icons or other types of selector tools that are selectable through user interface 114 by users 101 to instruct property fraud prevention application 106 to perform particular processes in response to the selections.

Computing devices 110 may be in communication with one or more servers such as server 104 via one or more networks such as network 102. Server 104 may be located at a data center or any other location suitable for providing service to network 102 whereby server 104 may be in one central location or in many different locations in multiple arrangements. Server 104 may comprise a database server such as MySQL or MariaDB server. Server 104 may have an attached data storage system storing software applications and data. Server 104 may receive requests and coordinate fulfillment of those requests through other servers. Server 104 may comprise computing systems similar to computing devices 110.

Server 104 may include a number of modules that provide various functions related to property fraud prevention application 106 and property fraud prevention system 100 using one or more computing devices similar to computing device 110. Modules may be in the form of software or computer programs that interact with the operating system of server 104 whereby data collected in one or more databases (such as databases 108) may be processed by one or more processors within server 104 or computing device 110 as well as in conjunction with execution of one or more other computer programs. Property fraud prevention system 100 includes several key functional modules including a Property Registration Module 120, a Biometric Verification Module 122, a Fraud Scoring Engine 124, a Title Locking Mechanism 126, a Residency Monitoring Module 128, a Disaster Risk Integration Module 130, a Verification Portal Module 132, and a Verification Portal Module 132.

Property Registration Module 120 is designed to receive and process deed records, property information, and owner registration data. This module interfaces with county recording offices, title companies, and other sources of property ownership information to establish baseline property records within the system.

Biometric Verification Module 122 is designed to capture, process, and authenticate biometric data including fingerprints, facial recognition patterns, iris scans, and voice patterns. This module employs industry-standard biometric authentication algorithms and securely stores biometric templates in encrypted format within databases 108. The module can interface with external identification verification services and government databases for cross-validation.

Fraud Scoring Engine 124 is designed to receive inputs from multiple data sources including deed records, lien filings, utility activations, mail delivery, and FEMA disaster data, creating a unified cross-domain fraud detection framework. The engine creates a composite fraud score by correlating data from all monitored sources and detecting fraudulent lien recordings or encumbrances filed without verified authorization. The fraud scoring engine employs both supervised and unsupervised learning techniques, training on historical fraud patterns while also detecting anomalous activity that may indicate novel fraud attempts. The AI models the sequence of property-lifecycle events (vacancy→utility activation→mail activit→lien or deed filing) to infer intent, not just anomalies, and builds a dynamic trust profile for each property using weighted signals from all data inputs. The engine continuously updates risk scores as new information becomes available.

Title Locking Mechanism 126 is designed to implement digital security controls that prevent or restrict deed transfers and modifications. When a property's deed is locked, any attempt to file a transfer, modify ownership records, or conduct other deed-related transactions triggers verification protocols requiring biometric authentication and owner authorization. The system also notifies the verified property owner in real time whenever a lien is recorded against their property, allowing the owner to immediately verify the lien's validity through the secure interface and preventing fraudulent or unexpected liens from interfering with property sales or closings.

Residency Monitoring Module 128 is designed to interface with utility companies, postal services, and other data sources to detect changes in property occupancy patterns. This module identifies unauthorized utility activations, mail forwarding requests, new mail recipients, and other indicators of occupancy changes that may signal squatting or fraud attempts.

Disaster Risk Integration Module 130 is designed to interface with FEMA databases, weather services, and emergency management systems to identify properties located in declared disaster zones. The module automatically adjusts fraud risk scores for properties in high-risk areas and may implement enhanced monitoring protocols.

Verification Portal Module 132 is designed to provide law enforcement personnel with field-accessible tools for instantly verifying property ownership, lease validity, and fraud risk status. The portal functions as a real-time verification tool that enables officers to confirm ownership, lease authenticity, and view the property's current fraud score in the field, serving as a practical technical application that supports patent eligibility. The portal provides mobile-optimized interfaces for use on patrol devices and includes integration with law enforcement record management systems.

Cross-Agency API Module 134 is designed to enable secure data exchange between property fraud prevention system 100 and external entities including title companies, law enforcement agencies, utility providers, and government offices. The API implements industry-standard security protocols and supports both real-time queries and batch data synchronization.

Databases 108 may be a repository that may be written to and/or read by property fraud prevention application 106. Information gathered from property fraud prevention application 106 may be stored to databases 108 as well as any analysis techniques, metadata, and additional data that property fraud prevention application 106 may be used to analyze, extract, create, and associate with property records. In one embodiment, databases 108 may be a database management system (DBMS) used to allow the definition, creation, querying, update, and administration of one or more databases. In the depicted embodiment, databases 108 resides on server 104. In other embodiments, databases 108 resides on another server, or another computing device, or remotely from the system, as long as databases 108 are accessible to property fraud prevention application 106 Databases 108 may include several logical databases including: a property records database storing deed information, ownership history, and property characteristics; a biometric database storing encrypted biometric templates and authentication records; a fraud database storing fraud risk scores, alerts, and historical fraud events; a user database storing registered user accounts and access permissions; a lease registry database storing verified lease agreements and occupancy records; and an event log database storing tamper-evident audit logs of all system activities.

In one or more non-limiting embodiments, network 102 may include a local area network (LAN), such as a company Intranet, a metropolitan area network (MAN), or a wide area network (WAN), such as the Internet or World Wide Web. Network 102 may be a private network, a public network, or a combination thereof. Network 102 may be any type of network known in the art, including a telecommunications network, a wireless network (including Wi-Fi), and a wireline network.

Network 102 may include mobile telephone networks utilizing any protocol or protocols used to communicate among mobile digital computing devices (e.g., computing device 110), such as GSM, GPRS, UMTS, AMPS, TDMA, or CDMA. In one or more non-limiting embodiments, different types of data may be transmitted via network 102 via different protocols. Network 102 may employ one or more cellular access technologies including but not limited to: 2nd (2G), 3rd (3G), 4th (4G), 5th (5G), LTE, Global System for Mobile communication (GSM), General Packet Radio Services (GPRS), Enhanced Data GSM Environment (EDGE), and other access technologies.

Property fraud prevention system 100 may also include one or more administrative entities such as administrative entity 112. While administrative entity 112 is depicted as a single element communicating over network 102, administrative entity 112 in one or more non-limiting embodiments may be distributed over network 102 in any number of physical locations. Administrative entity 112 may manipulate the software and enter commands to server 104 using any number of input devices such as keyboard and mouse. The input/output may be viewed on a display screen to administrative entity 112.

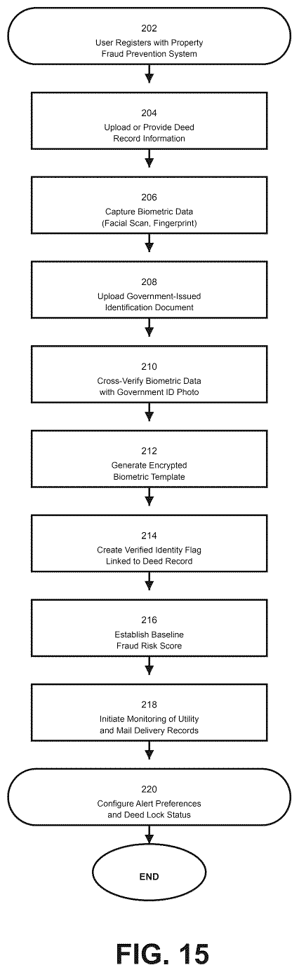

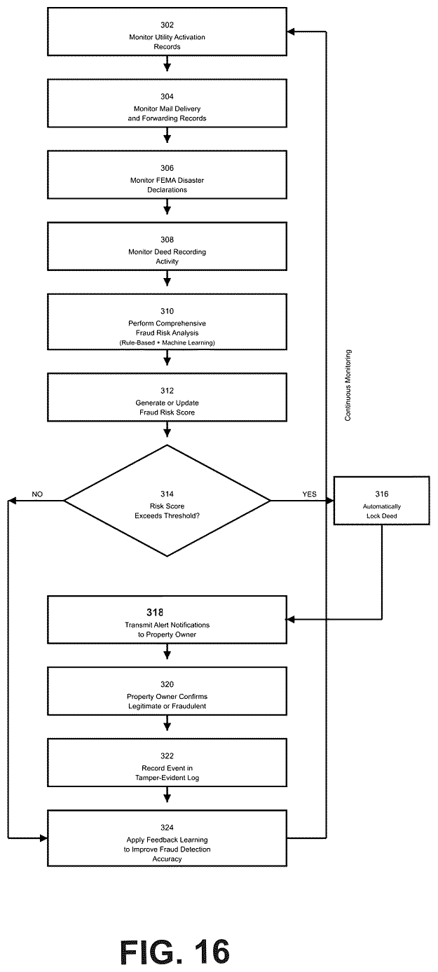

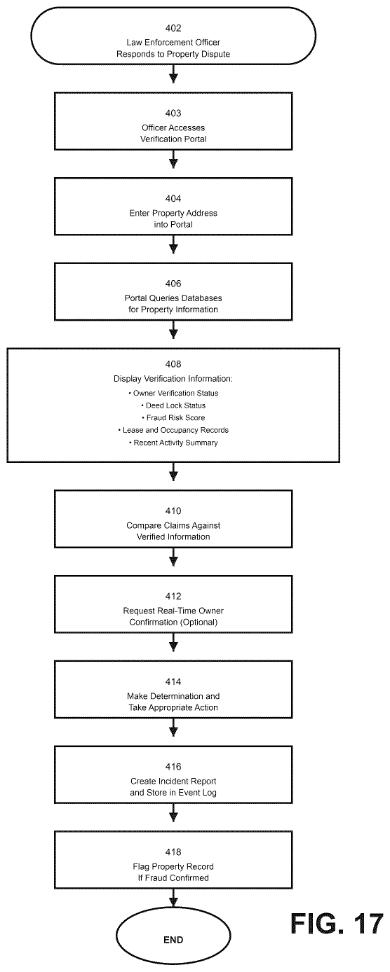

FIG. 15 illustrates a flowchart depicting an exemplary method for property owner registration and biometric verification whereby one or more components included in FIG. 14, such as, without limitation, computing devices 110, server 104, and network 102 may be utilized while implementing the method. FIG. 15 depicts a flowchart of the operational steps taken by property fraud prevention application 106 to register a property owner, capture and verify biometric data, cross-reference with government identification, link biometric identity to the deed record, and establish baseline fraud monitoring.

At step 202, users 101 may initially register to become a registered user associated with property fraud prevention system 100. Users 101 access property fraud prevention application 106 via computing device 110 and are presented with a registration interface through user interface 114. During registration, users 101 provide basic information including name, contact information, and property address.

At step 204, users 101 upload or provide deed record information associated with the property they wish to protect. This may include uploading a PDF copy of the recorded deed, providing the deed book and page number, or providing the property's parcel identification number. This may also be collected instead from third-party sources such as external databases which have preexisting linked accounts. Property registration module 120 then receives this information and validates it against public property records to confirm that the user is the recorded owner of the property whereby the system may analyze government record platforms utilizing cross-agency API module 134 or manually uploaded records that have been crowdsourced.

At step 206, users 101 may be prompted to complete biometric verification. Biometric verification module 122 may activate a camera on computing device 110 or another remote device and guides users 101 through capturing biometric data. In one embodiment, users 101 capture a facial scan by positioning their face within a displayed frame and allowing the system to capture multiple images from different angles. In other embodiments, users 101 may additionally or alternatively provide fingerprint scans using a fingerprint sensor on computing device 110 and/or provide other biometric inputs such as iris scans or voice samples.

The biometric capture process may employ liveness detection techniques to ensure that the biometric sample is from a live person and not a photograph, video, or other spoofing attempt. Such liveness detection may include prompting the user to perform specific actions such as blinking, turning their head, or speaking specific phrases.

At step 208, users 101 may be prompted to photograph or upload their government-issued identification document such as a driver's license or passport. The system employs optical character recognition (OCR) to extract information from the identification document including name, date of birth, identification number, and photograph.

At step 210, biometric verification module 122 performs cross-verification between the biometric data captured in step 206 and the photograph on the government identification document captured in step 208. The system employs facial recognition algorithms to confirm that the live biometric capture matches the photograph on the government identification, ensuring that the person registering the property is the same person depicted on the government identification.

At step 212, biometric verification module 122 generates a biometric template from the captured biometric data. The biometric template is a mathematical representation of the biometric characteristics that allows for future authentication without storing the actual biometric images. The biometric template is encrypted using hardware-level encryption within secure enclave 140 and stored in databases 108.

At step 214, property registration module 120 creates a verified identity flag associated with the property's deed record. This verified identity flag indicates that the owner has completed biometric registration and links the encrypted biometric template to the specific property. The verified identity flag may be stored within databases 108 and may also be communicated to external systems such as title companies or government recording offices through cross-agency API module 134.

At step 216, fraud scoring engine 124 may establish a baseline fraud risk score for the property. The baseline score may be calculated using factors such as the property's location, ownership history, whether the property is in a disaster-prone area, and other risk factors. The factors may be weighted in determining the baseline score depending on the location of the property and what type of fraud is more prevalent in the area The establishment of a baseline score allows the system to detect deviations from normal patterns in the future.

At step 218, residency monitoring module 128 initiates monitoring of utility records, mail delivery records, and other occupancy indicators for the property. The module establishes baseline patterns of utility usage and mail delivery against which future changes can be compared.

At step 220, users 101 are provided with options to configure alert preferences, set deed lock status, and customize other settings. Users may elect to lock their deed immediately, may set thresholds for fraud risk score alerts, and may configure communication preferences for receiving alerts.

Upon completion of the registration process, the property owner's biometric identity is securely linked to their property deed record within property fraud prevention system 100, comprehensive monitoring is activated, and the property owner gains access to the fraud prevention dashboard and other system features.

FIG. 16 illustrates a flowchart depicting an exemplary method for continuous fraud detection, risk scoring, and automated deed locking whereby one or more components included in FIG. 14, such as, without limitation, computing devices 110, server 104, and network 102 may be utilized while implementing the method. FIG. 16 depicts a flowchart of the operational steps taken by property fraud prevention application 106 to continuously monitor multiple data sources, analyze fraud risk factors, generate and update fraud risk scores, and automatically implement deed locking when fraud is detected.

At step 302, residency monitoring module 128 continuously monitors utility activation records for the protected property. The module interfaces with utility company databases through cross-agency API module 134 to receive notifications when electricity, gas, water, or other utilities are activated, deactivated, or transferred to a new account holder at the property address. The module compares detected utility activity against expected patterns established during the registration process.

At step 304, residency monitoring module 128 continuously monitors mail delivery records for the protected property. The module interfaces with USPS and private mail carrier databases to detect changes in mail forwarding status, addition of new mail recipients at the property address, or patterns of mail delivery consistent with occupancy. The module may employ anomaly detection to identify unusual patterns such as mail being forwarded shortly after a property becomes vacant.

At step 306, disaster risk integration module 130 continuously monitors FEMA disaster declarations and other emergency management data sources. When a property is located within a geographical area subject to a disaster declaration, the module automatically flags the property as being at elevated risk. Natural disasters create opportunities for fraud as properties may be vacant, owners may be displaced, and public records systems may be disrupted. The module may also monitor weather forecasts, wildfire risk maps, and other predictive data sources to provide advance warning of elevated risk.

At step 308, property registration module 120 continuously monitors deed recording activity at the county recording office or other governmental entity responsible for maintaining property records. The module may interface with county systems through cross-agency API module 134 or may employ web scraping or other automated monitoring techniques. The module detects when new documents are filed against the property including deeds, mortgages, liens, or other recorded instruments.

At step 310, fraud scoring engine 124 receives all monitoring inputs from the various data sources and performs comprehensive fraud risk analysis. The fraud scoring engine 124 employs a hybrid approach combining rule-based logic with machine learning models.

The rule-based component applies predefined rules that flag specific combinations of risk factors. For example, a rule may specify that utility activation at a vacant property during a declared disaster creates high fraud risk. Another rule may specify that filing of a deed transfer document for a property where the owner has activated deed lock constitutes potential fraud.

The machine learning component employs trained models that learn patterns from historical fraud cases and legitimate property activity. The models may employ supervised learning techniques trained on labeled data sets of known fraud cases and legitimate transactions. The models may also employ unsupervised learning techniques such as clustering and anomaly detection to identify unusual patterns that may indicate novel fraud attempts not represented in the training data.

At step 312, fraud scoring engine 124 generates or updates the fraud risk score for the property. The fraud risk score may be expressed as a numerical value (e.g., 0-100) or as a categorical assessment (e.g., Low, Medium, High, Critical). The fraud risk score reflects the cumulative assessment of all risk factors and may be weighted based on the relative importance of different indicators.

At step 314, the system determines whether the fraud risk score exceeds a threshold that triggers automated deed locking. Different threshold levels may be configured by the property owner or may be set by default based on best practices such as factoring time of year, location, and previous attempts. For example, a “High” risk score may trigger automatic deed locking unless the property owner has specifically opted out of automatic locking.

If the fraud risk score exceeds the threshold, the process proceeds to step 316 where title locking mechanism 126 automatically locks the deed record. Deed locking may be implemented through multiple technical mechanisms depending on the integration level with county recording systems. In jurisdictions where property fraud prevention system 100 has direct integration with the county recording system, the lock may be implemented as a flag in the county's database that prevents acceptance of new filing documents without additional verification. In jurisdictions without such integration, the lock may be implemented within property fraud prevention system 100 with alerts sent to county personnel when filing attempts are detected.

At step 318, when a deed is locked, property fraud prevention application 106 transmits alert notifications to the property owner through all configured communication channels. Alert notifications may be delivered via push notification to a mobile application, SMS text message, email, phone call, or API webhook to external systems. The alert notification provides details of the specific risk factors that triggered the lock and provides the property owner with options for responding.

At step 320, the alert notification provides the property owner with the ability to confirm whether the detected activity is legitimate or fraudulent on their computing device. If the property owner indicates that the activity is legitimate (for example, the owner initiated a utility activation for a renovation project), the owner may unlock the deed through biometric re-authentication on their computing device. If the property owner indicates that the activity is fraudulent or if the owner does not respond within a specified time period, the deed remains locked and additional security protocols may be initiated.

At step 322, all fraud detection events, alerts, and owner responses are recorded in the event log database within databases 108. The event log employs tamper-evident logging techniques such as blockchain or other cryptographic chaining methods to ensure the integrity and non-repudiation of the log records. The event log may be accessed by the property owner, authorized auditors, or law enforcement personnel for investigation purposes.

At step 324, fraud scoring engine 124 employs feedback learning to continuously improve fraud detection accuracy. When the property owner confirms that detected activity was legitimate, this feedback is used to reduce the weight of similar patterns in future fraud scoring, thereby reducing false positives. When the property owner confirms that detected activity was fraudulent, or when confirmed fraud cases are identified through other means, this feedback is used to increase the weight of similar patterns and may be incorporated into the training data for machine learning models.

The fraud detection and deed locking process operates continuously in real-time, providing 24/7 protection against property fraud attempts. The system's ability to automatically lock deeds when fraud is suspected provides a critical defensive capability that prevents fraudulent transfers from being completed while the property owner is unaware or unable to respond immediately.

FIG. 17 illustrates a flowchart depicting an exemplary method for law enforcement verification of property ownership and occupancy whereby one or more components included in FIG. 14, such as, without limitation, computing devices 110, server 104, and network 102 may be utilized while implementing the method. FIG. 17 depicts a flowchart of the operational steps taken by property fraud prevention application 106 to provide law enforcement officers with instant field verification capabilities for resolving property disputes, validating lease claims, and identifying fraudulent occupants.

At step 402, a law enforcement officer responds to a call involving a property dispute, potential trespassing, or other property-related incident. The officer may have been dispatched to investigate a complaint from a property owner, may have encountered suspicious activity during patrol, or may be responding to a dispute between multiple parties claiming rights to a property.

At step 403, the law enforcement officer accesses verification portal module 132 via a computing device 110 such as a mobile phone, tablet, or patrol computer. The officer has been previously authenticated and authorized to access the verification portal through a registration process that verified the officer's credentials and affiliation with a recognized law enforcement agency. Access to the verification portal may require multi-factor authentication to ensure security.

At step 404, the officer enters the property address into the verification portal. User interface 114 of the verification portal provides a streamlined search interface optimized for field use, with features such as auto-completion of addresses, GPS-based property identification, and voice input capabilities.

At step 406, verification portal module 132 queries databases 108 to retrieve all relevant information associated with the specified property. The query may retrieve information from multiple logical databases including property records database, biometric database, fraud database, lease registry database, and event log database.

At step 408, verification portal module 132 transmits the query results to the officer's computing device 110 and displays the information through user interface 114. The verification portal display may present multiple categories of information in an easily scannable format optimized for quick decision-making in the field.

The verification portal display includes an owner verification section which presents information about the verified property owner including name, biometric verification status (indicating whether the owner has completed biometric registration), and contact information. If the owner has completed biometric registration, a distinctive indicator such as a verification badge or checkmark is displayed, providing the officer with confidence that the ownership information has been thoroughly verified.

The verification portal display may include a deed lock status section which indicates whether the property's deed is currently in a locked status. If the deed is locked, the officer is informed that the property owner has implemented enhanced security controls and that any claims of recent ownership transfer should be treated with suspicion.

The verification portal display may include a fraud risk score section which presents the current fraud risk score for the property along with a summary of the key risk factors contributing to the score. This provides the officer with contextual information about whether the property has characteristics or recent activity associated with elevated fraud risk.

The verification portal display may include a lease and occupancy section which provides information about any verified leases or rental agreements associated with the property. If the property owner has registered one or more legitimate lease agreements in the lease registry database, these are displayed along with lessee names and lease term dates. This allows the officer to quickly validate whether an occupant claiming to be a tenant has a legitimate lease.

The verification portal display includes a recent activity section which provides a summary of recent events and alerts associated with the property, such as recent utility activations, mail delivery changes, or deed activity. This provides the officer with awareness of recent changes that may be relevant to the current investigation.

At step 410, the officer may use the verification portal to compare information presented by parties at the scene against the verified information in property fraud prevention system 100. For example, if an occupant claims to be renting the property and presents a lease agreement, the officer can check whether that lease is registered in the verified lease database. If the presented lease is not found in the verified lease database, the officer is alerted that the lease may be fraudulent.

At step 412, the officer may use the verification portal to request additional verification. In one embodiment, verification portal module 132 may initiate a real-time communication with the verified property owner, sending an SMS or push notification alerting the owner that law enforcement is at the property and requesting confirmation of the situation. The property owner may respond through the mobile application, confirming whether the occupant is authorized or whether the situation appears to be an unauthorized occupancy.

At step 414, based on the verified ownership information, fraud risk indicators, lease validation results, and any real-time owner confirmation, the officer makes a determination about the legitimacy of the various parties' claims and takes appropriate action. The verification portal provides the officer with documented evidence that may support arrest decisions, eviction proceedings, or other legal actions.

At step 416, the officer may use the verification portal to create an incident report documenting the property dispute investigation. The incident report is stored in the event log database and is associated with the property record. This creates a documented history of law enforcement involvement at the property which may be valuable for pattern analysis and for supporting future legal proceedings.

At step 418, if the investigation reveals confirmed fraud or other criminal activity, the officer may flag the property record with relevant information. This flag alerts other officers who may subsequently respond to calls at the property and contributes data that fraud scoring engine 124 may use to refine fraud detection models.

The law enforcement verification process provides officers with a powerful tool analogous to running a license plate check on a vehicle, but for property. Just as officers can instantly determine whether a vehicle is stolen, whether the driver is the registered owner, and whether there are outstanding warrants or alerts associated with the vehicle, the verification portal allows officers to instantly determine whether an occupant is the verified owner, whether there are fraud alerts associated with the property, and whether presented lease claims are valid. This capability reduces the time and effort required to resolve property disputes in the field, reduces the likelihood of legitimate property owners being denied access to their own property due to fraudulent claims, and provides law enforcement with the tools needed to effectively combat property fraud and squatting.

Property fraud prevention system 100 operates within a hybrid-cloud architecture designed to meet stringent security, compliance, and performance requirements. The system may utilize Microsoft Azure Government as the primary compliance backbone, providing a system of record that meets FedRAMP High, CJIS, and ITAR compliance requirements. Azure Government provides the infrastructure for databases 108, hosting property records database, biometric database, user database, lease registry database, and event log database. All data stored in Azure Government remains within U.S. sovereign jurisdiction and is protected by government-grade security controls.

The system may utilize Google Cloud Platform with FedRAMP certification to provide analytics and AI fraud scoring capabilities. Google Cloud hosts fraud scoring engine 124 and provides access to advanced machine learning services including Big Query for large-scale data analytics and Vertex AI for machine learning model training and inference. The use of Google Cloud allows the system to leverage cutting-edge AI capabilities while maintaining compliance with federal requirements.

The system may utilize Intel Confidential Computing technology to implement secure enclave 140, which provides hardware-level encrypted enclaves protecting critical workloads. Secure enclave 140 is used to process biometric verification operations, ensuring that biometric data is processed in a trusted execution environment with hardware-level isolation. Even administrators with root access to the underlying systems cannot access data being processed within secure enclave 140, providing defense-in-depth security for the most sensitive biometric information.

Data flow between the Azure Government environment, Google Cloud environment, and secure enclaves is orchestrated through encrypted channels with mutual authentication. Cross-agency API module 134 provides secure interfaces for external entities to interact with property fraud prevention system 100 while maintaining strict access controls and audit logging.

FIG. 18 depicts a block diagram of computing device 110 which may be used by property owners, law enforcement personnel, title company staff, or other users to interact with property fraud prevention system 100. Computing device 110 may comprise hardware components that allow access to property fraud prevention application 106.

Computing device 110 may include one or more input devices such as input devices 365 that provide input to a CPU (processor) such as CPU 360. Input devices 365 may include but are not limited to a mouse, a keyboard, a touchscreen, biometric sensors (fingerprint scanner, iris scanner, facial recognition camera), a microphone, or other user input devices.

CPU 360 may be a single processing unit or multiple processing units in a device or distributed across multiple devices. CPU 360 may be coupled to other hardware devices with the use of a bus. CPU 360 may communicate with a hardware controller for devices, such as for a display 370.

Display 370 may be used to display text and graphics of user interface 114. In some examples, display 370 provides graphical and textual visual feedback to a user including property fraud prevention dashboards, alert notifications, verification portal interfaces, and other information displays. In one or more embodiments, display 370 may include an input device 365 as part of display 370, such as when input device 365 is a touchscreen.

CPU 360 may have access to a memory such as memory 380. Memory 380 may include program memory such as program memory 382 capable of storing programs and software, such as an operating system such as operating system 384, property fraud prevention application 106, and other application programs. Memory 380 may also include data memory such as data memory 390 that may include cached property data, user preferences, configuration data, and other information.

Computing device 110 may be any computing device including but not limited to a smartphone, tablet, laptop computer, desktop computer, wearable device, smart watch, body camera, patrol computer, or any other device capable of executing property fraud prevention application 106. Computing device 110 may have location tracking capabilities such as GPS whereby it may determine its geographical location, which may be used for features such as automatic property identification based on proximity or location-based fraud risk assessment.

In one or more non-limiting embodiments, property fraud prevention system 100 may include closing table verification capabilities. When a property closing transaction is scheduled, title locking mechanism 126 may coordinate with the title company to require biometric re-verification of the seller at the closing table. Prior to allowing the deed transfer to proceed, the seller must complete biometric authentication using the same biometric modality (fingerprint, facial scan, etc.) that was used during initial registration. Biometric verification module 122 compares the closing-table biometric sample against the registered biometric template and only allows the transaction to proceed if there is a positive match. This prevents imposters from completing fraudulent sales using forged identification documents.

In one or more non-limiting embodiments, residency monitoring module 128 may employ sophisticated pattern analysis to distinguish legitimate utility usage from suspicious activity. For example, the module may analyze the patterns of utility consumption at a vacant property to differentiate between a contractor performing renovation work (characterized by daytime electricity usage consistent with power tools) versus a squatter (characterized by evening and nighttime usage consistent with residential occupancy). This reduces false positives while maintaining sensitivity to fraudulent occupancy.

In one or more non-limiting embodiments, property fraud prevention system 100 may integrate with existing property monitoring services, title insurance companies, and real estate platforms. Cross-agency API module 134 may provide integration capabilities allowing property owners to consolidate multiple services into a unified fraud prevention platform. For example, a property owner who already subscribes to a title monitoring service may link that service to property fraud prevention system 100 to gain enhanced biometric verification and law enforcement access capabilities.

In one or more non-limiting embodiments, property fraud prevention system 100 may provide bulk registration capabilities for entities that own multiple properties such as real estate investment companies, property management firms, or government entities. Administrative entity 112 may provide bulk data import tools, consolidated dashboards showing fraud risk across entire property portfolios, and enterprise-level alert management.

In one or more non-limiting embodiments, verification portal module 132 may integrate with law enforcement computer-aided dispatch (CAD) systems and records management systems (RMS). When a call is dispatched involving a property address, the integration may automatically retrieve and display verification portal information in the officer's patrol computer or mobile device without requiring manual address entry. This seamless integration accelerates officer response and ensures that critical property ownership information is immediately available.

In one or more non-limiting embodiments, property fraud prevention system 100 may employ geographic risk mapping. The system may generate heat maps and risk overlays showing geographic patterns of fraud attempts, disaster zones, and high-risk areas. Property owners may visualize their property in relation to these risk factors, and fraud scoring engine 124 may apply geographic risk factors when calculating fraud risk scores In one or more non-limiting embodiments, property fraud prevention system 100 may provide educational resources and fraud prevention guidance to property owners. User interface 114 may present contextual tips and recommendations based on the property's specific characteristics and risk profile, educating owners about fraud prevention best practices and helping them make informed decisions about security settings In one or more non-limiting embodiments, property fraud prevention system 100 may generate compliance reports and audit trails for regulatory and legal purposes. Event log database maintains comprehensive records of all system activities in tamper-evident format, and the system may generate reports suitable for presentation in legal proceedings, insurance claims, or regulatory investigations.

Property fraud prevention system 100 represents a significant technical improvement over traditional property monitoring and fraud prevention systems. Unlike passive monitoring services that merely alert owners to recorded deed activity after the fact, the present invention provides proactive, multi-layered fraud prevention that can block fraudulent transactions before they are completed.

The integration of biometric identity verification with property deed records represents a novel technical approach that fundamentally strengthens the chain of ownership verification. By requiring biometric authentication for both initial registration and subsequent critical transactions such as closings, the system ensures that only the legitimate property owner can authorize ownership transfers.

The AI-powered fraud scoring engine represents a technical advancement over rule-based fraud detection systems. By employing machine learning models trained on historical fraud patterns and continuously refined through feedback learning, the system can detect both known fraud patterns and novel fraud attempts that may not match predetermined rules. The system's ability to integrate and analyze disparate data sources including deed records, utility activations, mail delivery patterns, and disaster declarations provides a comprehensive fraud risk assessment that is not available through any single data source.

The title locking mechanism provides a concrete fraud prevention capability rather than merely detecting fraud after it occurs. By implementing technical controls that prevent deed recording without proper authorization and authentication, the system creates a defensive barrier that stops fraudulent transfers at the earliest possible stage.

The law enforcement verification portal addresses a critical gap in property fraud enforcement. Historically, law enforcement officers responding to property disputes have had limited tools for quickly verifying ownership and validating lease claims in the field. The verification portal provides officers with instant access to verified ownership information, biometric verification status, lease validation, and fraud risk indicators, enabling officers to make informed decisions and take appropriate action to protect legitimate property owners.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A system for preventing property fraud, comprising:
a property registration module configured to receive a deed record associated with a property;
a verification system;
a fraud scoring system configured to receive inputs comprising property ownership history, utility records, mail delivery records, and disaster-related data;
generate a fraud risk score associated with the property; and
a title locking mechanism configured to freeze or unfreeze the deed record based on the fraud risk score and biometric authentication.

2. The system of claim 1 further comprising a verification portal accessible by law enforcement, wherein the verification portal is configured to provide in real time at least one of: a verified owner identity, a deed lock status, the fraud risk score, or a record of valid leases associated with the property.

3. The system of claim 1, wherein the verification system is a biometric authentication system wherein the biometric authentication is re-confirmed during a property closing to prevent fraudulent transfer.

4. The system of claim 1, further comprising a fraud scoring engine wherein the fraud scoring engine applies both a rule-based baseline and a machine learning model to generate the fraud risk score.

5. The system of claim 1, wherein the property registration module stores a verification result as a verified identity flag linked to the deed record.

6. The system of claim 1, wherein the title locking mechanism requires a re-verification of an owner to unfreeze the deed record.

7. The system of claim 1, wherein a cross-agency verification system connects the system with title companies, law enforcement, and utility providers for ownership validation.

8. The system of claim 2, wherein the verification portal provides the law enforcement with an indicator of whether a lease presented by an occupant matches a verified lease record in the system.

9. The system of claim 4, wherein the fraud scoring engine increases the fraud risk score when the property is located within a disaster zone declared by Federal Emergency Management Agency (FEMA).

10. The system of claim 4, wherein the fraud scoring engine lowers the fraud risk score upon confirmation of owner activity consistent with verified utility activations.

11. The system of claim 4, wherein the fraud scoring engine raises the fraud risk score upon confirmation of owner activity not consistent with verified utility activations.

12. The system of claim 1, further comprising a residency monitoring module configured to generate alerts when new mail recipients are detected at a property address.

13. The system of claim 4, wherein the fraud scoring engine generates the fraud risk score on a continuous basis and updates the score upon receiving new ownership, utility, or mail activity.

14. The system of claim 1, wherein the system records each fraud-related event in a tamper-evident log accessible to authorized auditors.

15. The system of claim 1, wherein all modules operate within a secure enclave computing environment providing hardware-level encryption and data isolation.

16. The system of claim 1, wherein the system notifies a property owner in real time when a lien is recorded against the deed for verification by the property owner.

17. A computer-implemented method for preventing property fraud, comprising:
receiving, via a property registration system, a deed record associated with a property;
verifying an identity of a property owner;
automatically monitoring and parsing external datasets including at least one of:
ownership history, utility activation, mail delivery, and disaster zone data;
generating, by a fraud scoring engine, a fraud risk score for the property based on the external datasets and biometric authentication;
automatically locking the deed record when the fraud risk score exceeds a threshold; and
providing, via a law enforcement portal, real-time verification of an identity of the property owner, deed lock status, the fraud risk score, and lease validity.

18. The method of claim 17, wherein an AI engine continuously refines fraud predictions based on confirmed fraud or false-positive feedback.

19. The method of claim 17, wherein the fraud risk score is calculated using a machine learning model trained on historical deed fraud patterns.

20. (canceled)

21. (canceled)

22. (canceled)

23. (canceled)

24. (canceled)

25. (canceled)

26. (canceled)

27. (canceled)

28. (canceled)

29. (canceled)

30. The system of claim 1, wherein the fraud scoring system operates as an event-driven fraud detection pipeline configured to receive discrete event triggers from a plurality of monitoring modules, and in response to each event trigger, re-evaluate and update the fraud risk score associated with the property in real time.

31. The system of claim 30, wherein the discrete event triggers comprise: a new deed filing or deed transfer attempt detected by the property registration module; a utility activation at the property detected by a residency monitoring module; a change in mail delivery recipients at the property address detected by the residency monitoring module; and a disaster zone declaration affecting a geographical area containing the property received from a disaster risk integration module.

32. The system of claim 1, wherein the fraud scoring system creates a composite fraud score by correlating data across a plurality of heterogeneous data sources comprising deed recording activity, lien filing records, utility activation records, mail delivery records, and disaster zone data, thereby forming a unified cross-domain fraud detection framework.

33. The system of claim 32, wherein the fraud scoring system assigns weighted contributions from each of the plurality of heterogeneous data sources and generates the fraud risk score as a cumulative weighted assessment reflecting a combined risk profile across all data sources.

34. The system of claim 33, wherein the fraud scoring system employs both supervised learning techniques trained on labeled datasets of known fraud cases and legitimate transactions, and unsupervised learning techniques comprising anomaly detection to identify patterns indicating novel fraud attempts not represented in training data.

35. The system of claim 1, further comprising vacancy state enforcement logic configured to determine a vacancy status of the property based on at least utility usage patterns and mail delivery activity, wherein the fraud scoring system applies elevated monitoring protocols and increases the fraud risk score when the property is determined to be in a vacant state.

36. The system of claim 35, further comprising a residency monitoring module configured to distinguish between legitimate occupancy and unauthorized occupancy by analyzing temporal patterns of utility consumption at the property, wherein the residency monitoring module differentiates between daytime electricity usage consistent with renovation work and evening or nighttime electricity usage consistent with unauthorized residential occupancy.

37. The system of claim 2, wherein the verification portal operates as a real-time property verification query engine configured to receive a property address query from a law enforcement computing device and, in response, return a consolidated verification result comprising: a verified owner identity with biometric verification status, a current deed lock status, the fraud risk score with contributing risk factors, and a lease validation status indicating whether verified lease records exist for the property.

38. The system of claim 37, wherein the verification portal is further configured to interface with a law enforcement computer-aided dispatch system such that the consolidated verification result is automatically retrieved and displayed on a patrol computing device when a property-related call is dispatched to the property address.

39. A distributed computing system for real-time property fraud prevention, comprising: a first cloud computing environment configured to store encrypted property deed records, encrypted biometric templates, and lease registry data; a second cloud computing environment separate from the first cloud computing environment and configured to execute machine learning models for fraud risk analysis; a secure enclave providing hardware-level processor memory encryption and data isolation, the secure enclave configured to generate non-invertible biometric templates from captured biometric data and perform biometric template matching, wherein biometric data processed within the secure enclave is inaccessible to administrators with root access to the first or second cloud computing environments; a communication layer connecting the first cloud computing environment, the second cloud computing environment, and the secure enclave through encrypted channels with mutual TLS authentication; a plurality of monitoring modules configured to continuously ingest data from heterogeneous external data sources comprising at least deed recording activity, utility activation records, mail delivery records, and disaster zone data, and to generate discrete event triggers in response to detected changes in the data; a fraud scoring engine executing within the second cloud computing environment and configured to receive the discrete event triggers from the plurality of monitoring modules, correlate the data across the heterogeneous external data sources to generate a composite fraud risk score using weighted signal contributions from each data source, and update the composite fraud risk score in real time in response to each received event trigger; a title locking mechanism configured to freeze a deed record associated with a property when the composite fraud risk score exceeds a configurable threshold, thereby preventing transfer or modification of the deed record, and configured to unfreeze the deed record upon biometric re-verification of the property owner through the secure enclave.
